(19) United States
(12) Patent Application Publication
(10) Pub. No.: US 2024/0216802 A1
(43) Pub. Date: Jul. 4, 2024

(54) OPERATION CONTROL METHOD AND APPARATUS

(71) Applicant: Beijing Bytedance Network Technology Co., Ltd., Beijing (CN)

(72) Inventors: Hua Zheng, Beijing (CN); Yandong Cong, Beijing (CN); Zexin Zhou, Beijing (CN)

(21) Appl. No.: 18/012,610

(22) PCT Filed: May 27, 2021
(86) PCT No.: PCT/CN2021/096269

§ 371 Date: Dec. 22, 2022

(30) Foreign Application Priority Data
Jun. 24, 2020 (CN) 202010589705.7

(51) Int. Cl. A63F 13/52; A63F 13/213; G06T 7/70; G06V 40/16

(52) U.S. Cl. CPC A63F 13/52; A63F 13/213; G06T 7/70; G06V 40/161; G06V 40/174; G06T 2207/30201

(57) ABSTRACT

An operation control method and apparatus. The method comprises: acquiring a facial image of a target user; detecting position information of a target part in the facial image; on the basis of the detected position information, and at a relative position, corresponding to the detected position information, on the facial image, displaying a target virtual prop in an initial display form; and adjusting the display form of the target virtual prop according to detected state information of the target part.

### CROSS-REFERENCE TO RELATED APPLICATIONS

The present application claims the priority to Chinese Patent Application No. 202010589705.7, titled “OPERATION CONTROL METHOD AND APPARATUS”, filed on Jun. 24, 2020 with the Chinese Patent Office, which is incorporated herein by reference in its entirety.

### FIELD

The present disclosure relates to the technical field of Internet, and in particular to an operation control method and an operation control apparatus

### BACKGROUND

At present, with the continuous development of Internet technology, intelligent terminals are gradually popular in people's life and work, and the functions of various media software installed in the intelligent terminals are becoming more and more powerful. For example, a virtual prop, such as simulated shooting, may be operated by media software installed in an intelligent terminal. Based on this kind of software, the requirement for real materials may be reduced, saving costs and facilitating the statistics of operation results. However, the operations of virtual props mostly lack of realistic integration according to the conventional technology, resulting in that the real experience of the user is not strong.

### SUMMARY

At least an operation control method and an operation control apparatus are provided according to the embodiments of the present disclosure.

In a first aspect, an operation control method is provided according to an embodiment of the present disclosure. The method includes: obtaining a face image of a target user; detecting position information of a target part in the face image; based on the detected position information, displaying a target virtual prop, in an initial display form, at a relative position corresponding to the detected position information on the face image; and adjusting a display form of the target virtual prop based on detected state information of the target part.

In an embodiment, the display form includes a display shape and/or a display size.

In an embodiment, the adjusting a display form of the target virtual prop based on detected state information of the target part includes: adjusting the display form of the target virtual prop in a case that it is detected that a state attribute of the target part meets a preset state attribute condition and it is detected that a sound attribute meets a preset sound attribute condition.

In an embodiment, the adjusting the display form of the target virtual prop in a case that it is detected that a state attribute of the target part meets a preset state attribute condition and it is detected that a sound attribute meets a preset sound attribute condition includes: in the case that the state attribute of the target part meets the preset state attribute condition and the sound attribute meets the preset sound attribute condition, determining a display form adjustment range of the target virtual prop in a time period based on detected face shape change information of the target user; and adjusting the display form of the target virtual prop based on the determined display form adjustment range.

In an embodiment, the adjusting a display form of the target virtual prop based on detected state information of the target part includes: in a case that a state attribute of the target part meets a preset state attribute condition, determining a display form adjustment range of the target virtual prop in a time period based on detected face shape change information of the target user; and adjusting the display form of the target virtual prop based on the determined display form adjustment range.

In an embodiment, in a case that the target part is a mouth and the target virtual prop is a virtual balloon, that the state attribute of the target part meets the preset state attribute condition includes that the target part is in a mouth-pouting state.

In an embodiment, that the sound attribute meets the preset sound attribute condition includes that it is detected that a sound volume is greater than a preset threshold and/or it is detected that a sound type is a preset sound type.

In an embodiment, after adjusting the display form of the target virtual prop based on the detected state information of the target part, the method further includes: after adjusting the display form of the target virtual prop to meet a preset condition, displaying a target animation effect corresponding to the target virtual prop.

In an embodiment, in a case that the target part is a mouth and the target virtual prop is a virtual balloon, the displaying a target animation effect corresponding to the target virtual prop includes: displaying a target animation effect that the virtual balloon is blown up or blown away.

In an embodiment, the after adjusting the display form of the target virtual prop to meet a preset condition, displaying a target animation effect corresponding to the target virtual prop includes: based on prop attribute information of the target virtual prop, displaying a target animation effect matching the prop attribute information.

In an embodiment, after adjusting the display form of the target virtual prop based on the detected state information of the target part, the method further includes: after adjusting the display form of the target virtual prop to meet a preset condition, updating a recorded successful operation number, and displaying the target virtual prop in the initial display form.

In an embodiment, the method further includes: obtaining a personalized to-be-added object; and generating the target virtual prop based on the obtained personalized to-be-added object and a preset virtual prop model.

In an embodiment, the method further includes: displaying an auxiliary virtual prop in a preset position region on a screen displaying the face image; and in response to adjusting the display form of the target virtual prop to meet a preset condition, changing a display effect of the auxiliary virtual prop.

In an embodiment, the face image of the target user includes face images of multiple target users. For each of the target users, based on detected position information of a target part of the target user, a target virtual prop, in an initial display form, is displayed at a relative position corresponding to the detected position information on a face image of the target user.

In an embodiment, the adjusting a display form of the target virtual prop based on detected state information of the target part includes: based on detected state information of target parts of all the target users and detected face shape change information of all the target users, determining a selected user from the target users, and adjusting a display form of a target virtual prop corresponding to the selected user.

In an embodiment, the adjusting a display form of the target virtual prop based on detected state information of the target part includes: based on detected state information of target parts of all the target users, adjusting a display form of a target virtual prop corresponding to each of the target users.

In an embodiment, the target virtual prop corresponds to a real target operation object in a real scenario, and a position of the target virtual prop relative to the target part matches a position of the real target operation object, when being operated in the real scenario, relative to the target part.

In a second aspect, an operation control method is provided according to an embodiment of the present disclosure. The method includes: obtaining a face image of a target user; displaying a target virtual prop in an initial form based on the obtained face image; and based on detected face expression information of the face image and detected sound information, adjusting a display form of the target virtual prop.

In a third aspect, an operation control apparatus is provided according to an embodiment of the present disclosure. The apparatus includes: an obtaining module, a detection module, a displaying module, and an adjustment module. The obtaining module is configured to obtain a face image of a target user. The detection module is configured to detect position information of a target part in the face image. The displaying module is configured to, based on the detected position information, display a target virtual prop in an initial display form at a relative position corresponding to the detected position information on the face image. The adjustment module is configured to adjust a display form of the target virtual prop based on detected state information of the target part.

In an embodiment, the display form includes a display shape and/or a display size.

In an embodiment, the adjustment module is configured to: adjust the display form of the target virtual prop in a case that it is detected that a state attribute of the target part meets a preset state attribute condition and it is detected that a sound attribute meets a preset sound attribute condition.

In an embodiment, the adjustment module is configured to: in the case that the state attribute of the target part meets the preset state attribute condition and the sound attribute meets the preset sound attribute condition, determine a display form adjustment range of the target virtual prop in a time period based on detected face shape change information of the target user; and adjust the display form of the target virtual prop based on the determined display form adjustment range.

In an embodiment, the adjustment module is configured to: in a case that a state attribute of the target part meets a preset state attribute condition, determine a display form adjustment range of the target virtual prop in a time period based on detected face shape change information of the target user; and adjust the display form of the target virtual prop based on the determined display form adjustment range.

In an embodiment, the target part is in a mouth-pouting state.

In an embodiment, that the sound attribute meets the preset sound attribute condition includes that it is detected that a sound volume is greater than a preset threshold and/or it is detected that a sound type is a preset sound type.

In an embodiment, the apparatus further includes a target animation effect displaying module. The target animation effect displaying module is configured to, after the display form of the target virtual prop is adjusted to meet a preset condition, display a target animation effect corresponding to the target virtual prop.

In an embodiment, the target animation effect displaying module is configured to display a target animation effect that a virtual balloon is blown up or blown away.

In an embodiment, the target animation effect displaying module is configured to, based on prop attribute information of the target virtual prop, display a target animation effect matching the prop attribute information.

In an embodiment, the apparatus further includes a counting update module. The counting update module is configured to, after the display form of the target virtual prop is adjusted to meet a preset condition, update a recorded successful operation number, and display the target virtual prop in the initial display form.

In an embodiment, the apparatus further includes a personalized setting module. The personalized setting module is configured to: obtain a personalized to-be-added object; and generate the target virtual prop based on the obtained personalized to-be-added object and a preset virtual prop model.

In an embodiment, the apparatus further includes an auxiliary virtual prop displaying module. The auxiliary virtual prop displaying module is configured to display an auxiliary virtual prop in a preset position region on a screen displaying the face image.

The auxiliary virtual prop displaying module is configured to, in response to that the display form of the target virtual prop is adjusted to meet a preset condition, change a display effect of the auxiliary virtual prop.

In an embodiment, the face image of the target user includes face images of multiple target users. The displaying module is further configured to, for each of the target users, based on detected position information of a target part of the target user, display a target virtual prop in an initial display form at a relative position corresponding to the detected position information on a face image of the target user.

In an embodiment, the adjustment module is further configured to, based on detected state information of target parts of all the target users and detected face shape change information of all the target users, determine a selected user from the target users, and adjust a display form of a target virtual prop corresponding to the selected user.

In an embodiment, the adjustment module is further configured to, based on detected state information of target parts of all the target users, adjust a display form of a target virtual prop corresponding to each of the target users.

In an embodiment, the target virtual prop corresponds to a real target operation object in a real scenario, and a position of the target virtual prop relative to the target part matches a position of the real target operation object, when being operated in the real scenario, relative to the target part.

In a fourth aspect, an operation control apparatus is provided according to an embodiment of the present disclosure. The apparatus includes: an obtaining module, a displaying module, and an adjustment module. The obtaining module is configured to obtain a face image of a target user. The displaying module is configured to display a target virtual prop in an initial form based on the obtained face image. The adjustment module is configured to, based on detected face expression information of the face image and detected sound information, adjust a display form of the target virtual prop.

In a fifth aspect, a computer device is provided according to an embodiment of the present disclosure. The computer device includes a processor, a memory, and a bus. The memory stores machine-readable instructions executable for the processor. The processor communicates with the memory via the bus when the computer device operates. The machine-readable instructions, when executed by the processor, cause the processor to perform the steps in the first aspect, or the steps in any one of the embodiments in the first aspect, or the steps in the second aspect.

In a sixth aspect, a computer-readable storage medium is provided according to an embodiment of the present disclosure. The computer-readable storage medium stores a computer program. The computer program, when executed by a processor, causes the processor to perform the steps in the first aspect, or the steps in any one of the embodiments in the first aspect, or the steps in the second aspect.

According to the embodiments of the present disclosure, the user may control a display form of a virtual prop in real time, realizing cooperative display of a face image of the user and the virtual prop, thereby enhancing the real experience of operating virtual props. In addition, virtual props replace real props, saving material costs, protecting environment (reducing real prop garbage), and facilitating the statistics of the operation results.

In order to make the above purposes, features and advantages of the present disclosure more apparent and understandable, detailed descriptions are provided below in conjunction with the accompanying drawings and with reference to the following embodiments.

### BRIEF DESCRIPTION OF THE DRAWINGS

In order to more clearly explain the technical solutions in the embodiments of the present disclosure, the drawings used in the embodiments are briefly introduced below. The drawings herein are incorporated into the specification and form a part of the specification. These drawings show the embodiments in the present disclosure and are used together with the specification to describe the technical solutions according to the present disclosure. It should be understood that the following drawings only show some embodiments of the present disclosure and are not intended to limit the scope of the present disclosure. For those skilled in the art, other drawings may be obtained from these drawings without any creative effort.

FIG. 1 shows a flow chart of an operation control method according to an embodiment of the present disclosure;

FIG. 2 shows a schematic diagram of an interface for obtaining a face image according to an embodiment of the present disclosure;

FIG. 3 shows a schematic diagram of an interface for displaying a target virtual prop in an initial form according to an embodiment of the present disclosure;

FIG. 4 shows a schematic diagram of an interface for displaying an adjusted target virtual prop according to an embodiment of the present disclosure;

FIG. 5 shows a schematic diagram of an interface for displaying a blowing up effect according to an embodiment of the present disclosure;

FIG. 6 shows a schematic diagram of an interface for displaying a blowing away effect according to an embodiment of the present disclosure;

FIG. 7 shows a schematic diagram of an interface for displaying a displaying effect of an auxiliary virtual prop according to an embodiment of the present disclosure;

FIG. 8 shows a schematic diagram of an interface for displaying target virtual props, in an initial form, corresponding to multiple target users according to an embodiment of the present disclosure;

FIG. 9 shows a schematic diagram of an interface for displaying adjusted target virtual props corresponding to multiple target users according to an embodiment of the present disclosure;

FIG. 10 shows a flow chart of an operation control method according to another embodiment of the present disclosure;

FIG. 11 shows a schematic diagram of an operation control apparatus according to an embodiment of the present disclosure;

FIG. 12 shows a schematic diagram of an operation control apparatus according to another embodiment of the present disclosure;

FIG. 13 shows a schematic diagram of an electronic device according to an embodiment of the present disclosure; and

FIG. 14 shows a schematic diagram of an electronic device according to an embodiment of the present disclosure.

### DETAILED DESCRIPTION OF THE EMBODIMENTS

In order to make the purpose, technical solutions and advantages of the embodiments of the present disclosure more clear, the technical solutions in the embodiments of the present disclosure are descripted clearly and completely in accordance with the drawings in the embodiments of the present disclosure. Apparently, the embodiments described below are only some embodiments of the present disclosure, rather than not all the embodiments of the present disclosure. Generally, the components in the embodiments of the present disclosure that are described and shown in the accompanying drawings may be arranged and designed with different configurations. Therefore, the following detailed description of the embodiments of the present disclosure shown in the drawings is not intended to limit the scope of the present disclosure required to be protected, and merely represents the selected embodiments of the present disclosure. Based on the embodiments of the present disclosure, all other embodiments obtained by those skilled in the art without creative work belong to the protection scope of the present disclosure.

Based on the above research, an operation control method and an operation control apparatus are provided according to the embodiments of the present disclosure. According to the present disclosure, the user may control a display form of a virtual prop in real time, realizing cooperative display of a face image of the user and the virtual prop, thereby enhancing the real experience of operating virtual props. In addition, virtual props replace real props, saving material costs, protecting environment (reducing real prop garbage), and facilitating the statistics of the operation results. Furthermore, according to the embodiments of the present disclosure, a display position of a target virtual prop is determined based on position information of a target part, so that the display position of the target virtual prop conforms to a relative position relationship in a real scenario, further enhancing the real experience.

The defects in the above solutions are all results of practice and careful study. Therefore, the discovery process of the above problems and the solutions provided according to the present disclosure for the above problems below should be a contribution to the present disclosure in the process of disclosure.

It should be noted that similar reference numerals and letters represent similar items in the following drawings. Therefore, once an item is defined in one drawing, it is unnecessary to further define and explain the item in subsequent drawings.

In order to facilitate understanding of the embodiments, an operation control method according to an embodiment of the present disclosure is firstly introduced in detail. The execution body of the operation control method according to the embodiment of the present disclosure is generally a computer device having certain computing capability. The computer device includes, for example, a terminal device, a server, or other processing devices. The terminal device may be a user equipment (UE), a mobile device, a user terminal, a terminal, a cellular phone, a cordless phone, a personal digital assistant (PDA), a handheld device, a computing device, an on-vehicle device, a wearable device, and the like. In some implementations, the operation control method may be performed by a processor executing computer-readable instructions stored in a memory.

Hereinafter, taking the execution body as a terminal device, an operation control method according to an embodiment of the present disclosure is described.

### First Embodiment

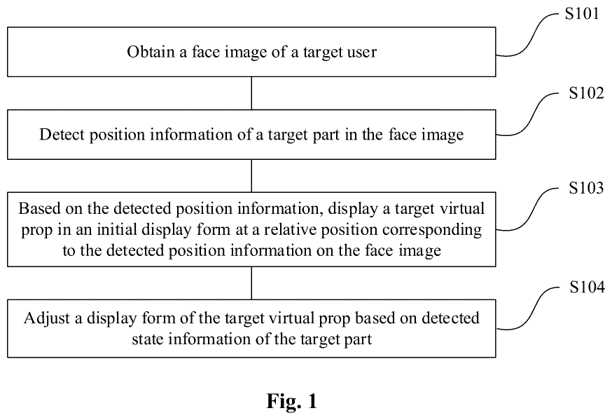

Reference is made to FIG. 1, which shows a flow chart of an operation control method according to an embodiment of the present disclosure. The method includes the following steps S101 to S104.

In step S101, a face image of a target user is obtained.

In an embodiment, the face image of the target user may be obtained by a front camera of a terminal device. Specifically, when the target user is within a shooting range of the front camera, the front camera will automatically search and shoot the face image of the target user. The terminal device may be a smart phone, a tablet, and the like.

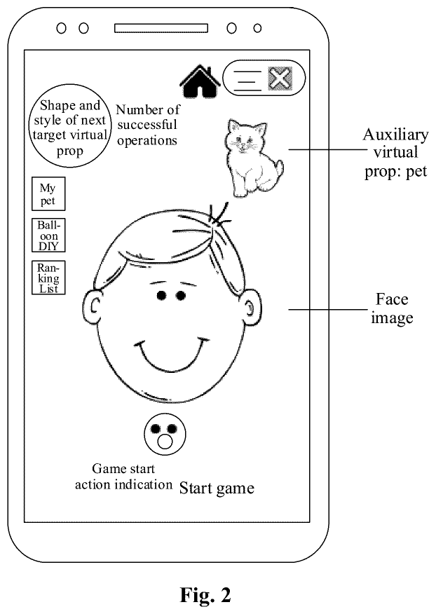

An interface for obtaining a face image of the user may include: a face image, an action prompt indicating the target user to start a game, information about a shape, a style and the like of a next target virtual prop, the number of successful operations, an auxiliary virtual prop, a “My pet” trigger button, a “Balloon DIY (Do It Yourself)” trigger button, a “Ranking list” trigger button, and other trigger buttons indicating the user to operate. The information about a shape, a style and the like of a next target virtual prop may be used to prompt the user about the shape, the style and the like of the next target virtual prop. The number of successful operations may indicate the number of times the user successfully blew out a balloon, that is, the number of balloons successfully blown up by the user. The “My pet” trigger button may be used to indicate the user to perform an operation on an auxiliary virtual prop of the user. The “Balloon DIY” trigger button may be used to indicate the target user to select a DIY object, such as a photo and a sticker, that the user like or is interested in, and indicate the user to design a target virtual prop. Taking the terminal device as a mobile phone, the interface for obtaining the face image of the user is shown in FIG. 2.

In step S102, position information of a target part in the face image is detected.

The target part may be a mouth. The position information of the target part indicates a position of the mouth on a screen of the terminal.

In implementation, feature extraction is performed on the face image based on the face image of the target user obtained in step S101. Based on a feature extraction result, a mouth image in the face image is determined, and a position of the mouth image on the screen of the terminal is determined.

In step S103, based on the detected position information, a target virtual prop in an initial display form is displayed at a relative position corresponding to the detected position information on the face image.

In an embodiment of the present disclosure, the target virtual prop may correspond to a real target operation object in a real scenario, and a position of the target virtual prop relative to the target part matches a position of the real target operation object, when being operated in the real scenario, relative to the target part. In addition, the way the user operates the target virtual prop matches the way the user operates the corresponding real target operation object in the real scenario, thereby further enhancing the real experience.

For example, the target virtual prop may be a balloon, and the relative position may be a position below the mouth. The style of the balloon may include many kinds, such as a rabbit style and a doughnut style.

In implementation, after it is detected that the user initiates a preset trigger operation based on the face image of the target user, the target virtual props display function in step S103 may be performed. For example, after it is detected that the user is making a mouth-pouting action, the virtual balloon is displayed.

In addition, in an embodiment of the present disclosure, the operations by the user on the target virtual prop may be counted and recorded. Thus, a time period may be provided for the user for preparing. In an embodiment, after the user initiates a preset trigger operation (such as making a mouth-pouting action), a countdown may be started, and the user is asked to prepare. When the countdown ends, the operation records of the user in a time period is counted.

The initial display form indicates a state of the target virtual prop in an initial display stage. For example, the target virtual prop in the initial display form may be a small balloon in a deflated state (that is, a state the balloon is not blown).

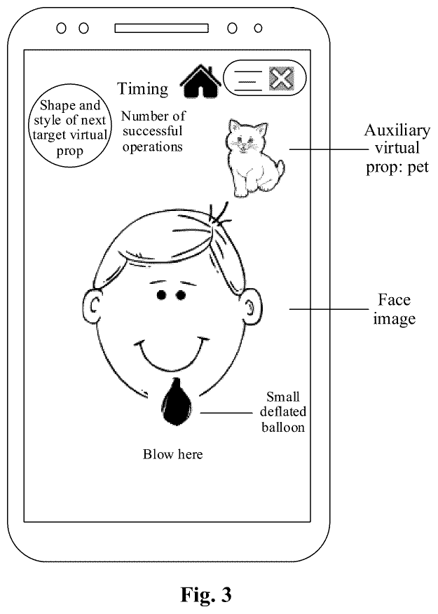

In an embodiment, based on the position of the mouth of the target user determined in step S102, the small balloon in the deflated state is displayed below the mouth. Taking the terminal device as a mobile phone, the display interface is shown in FIG. 3.

In step S104, a display form of the target virtual prop is adjusted based on detected state information of the target part.

In an embodiment, feature extraction may be performed on the image of the target part to determine the state information of the target part. The state information of the target part may include posture information, such as mouth-pouting information, of the target part. For example, the display form of the virtual balloon may be adjusted in a case that that the state information of the target part is the mouth-pouting information.

The display form of the target virtual prop may include a displayed shape and/or a display size. For example, the display shape of the virtual balloon may include a rabbit shape, a doughnut shape, and the like. The display size indicates an expansion degree of the balloon, and may be a size times an initial display size, for example, a size 1.5 times the initial display size.

In an embodiment, the display form of the target virtual prop may be adjusted based on the detected state information of the target part and detected sound information.

Specifically, feature extraction is performed on the face image of the target user to determine the state information of the mouth of the target user. Sound data of the target user is obtained, and the sound data is processed to determine sound information corresponding to the sound data. The display size of the balloon is adjusted based on the state information of the mouth and the sound information.

In implementation, the display size of the balloon is adjusted based on the state information of the mouth and the sound information. Specifically, the display form of the target virtual prop is adjusted in a case that a state attribute of the target part meets a preset state attribute condition and it is detected that a sound attribute meets a preset sound attribute condition.

The state attribute may include posture features and the like of the target part. For example, in the blowing balloon scenario, the state attribute of the mouth includes whether the mouth is pouted.

The preset state attribute condition may include a mouth-pouting action and different mouth-pouting ranges, including a mouth-pouting action at a slight range, a mouth-pouting action at a large range, and the like. That the state attribute of the target part meets the preset state attribute condition may be that the target part is in a mouth-pouting state.

The sound attribute condition may include a sound type, a sound volume, and a sound duration. In the blowing balloon scenario, the sound type includes a blowing sound type and other sound types. The sound volume may be obtained by detecting a volume of a sound of the target user. The sound duration indicate a time duration of a sound.

Exemplary, the preset sound attribute condition may include a condition in which the sound type is a blowing sound type (or the sound type may be not limited), the sound volume is greater than or equal to 1 decibel (which is only used for taking an example and is not an actual threshold in practices), the sound duration is greater than or equal to 3 seconds (or the sound duration may be not limited).

Exemplary, in a case that it is detected that the state attribute of the target part of the target user meets the preset state attribute condition (that is, the mouth is in the mouth-pouting state) and it is detected that the sound volume is greater than a preset threshold, the size of the balloon below the mouth is adjusted.

In an embodiment, that the sound attribute meets the preset sound attribute condition may be that it is detected that the sound volume is greater than a preset threshold and/or it is detected that the sound type is a preset sound type. For example, that a sound meets the preset sound attribute condition may be that a sound volume is greater than the preset threshold and a sound type is the blowing sound type.

Exemplary, in a case that it is detected that the state attribute of the target part of the target user meets the preset state attribute condition (that is, the mouth is in the mouth-pouting state) and it is detected that the sound attribute meets the preset sound attribute condition (that is, the sound type is the blowing sound type and the sound volume is greater than 1 decibel), the size of the balloon below the mouth is adjusted.

In an embodiment, the display form of the target virtual prop is adjusted in the case that it is detected that the state attribute of the target part meets the preset state attribute condition and it is detected that the sound attribute meets the preset sound attribute condition by: in the case that the state attribute of the target part meets the preset state attribute condition and the sound attribute meets the preset sound attribute condition, determining a display form adjustment range of the target virtual prop in a time period based on detected face shape change information of the target user; and adjusting the display form of the target virtual prop based on the determined display form adjustment range.

The face shape change information indicates a strength for making an action (such as, a strength for making the blowing action). The face shape change information may include a face shape change range, that is, a mouth opening range and a cheek bulging range.

The face shape change information may affect a balloon inflation speed. Specifically, the relationship between the face shape change information and the balloon inflation speed is described as follows. In a case that the mouth opening range and the cheek bulging range are large, the strength for performing the blowing action is large, and a corresponding balloon inflation speed is large. In a case that the mouth opening range and the cheek bulging range are small, the strength for performing the blowing action is small, and a corresponding balloon inflation speed is small.

Specifically, in the case that it is detected that the mouth of the target user is in the mouth-pouting state and it is detected that the sound meets the preset sound attribute condition, a mouth opening range and a cheek bulging range corresponding to the face of the target user are detected. Based on the mouth opening range and the cheek bulging range of the current target user and the determined relationship between the face shape change information and the balloon inflation speed, a change degree of the size of the balloon (that is, a balloon inflation degree) in a time period is determined. Based on the determined change degree of the size of the balloon in the time period, a display size of the balloon on the screen of the terminal is adjusted.

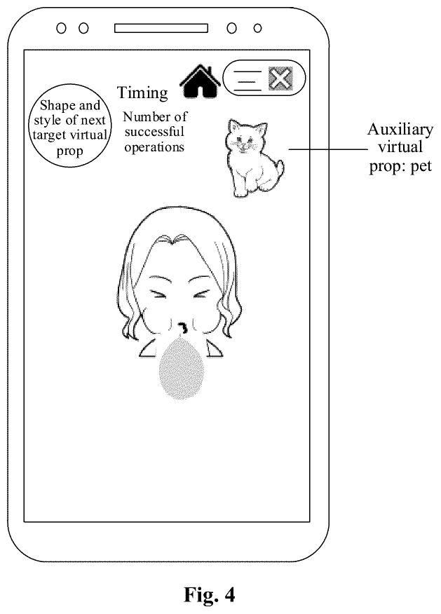

Exemplary, in a case that the current target user is performing a mouth-pouting action and the sound meets the preset sound attribute condition, and it is detected that the mouth opening range and the cheek bulging range corresponding to the face of the target user are large, the display size of the balloon on the screen of the terminal is adjusted at a large balloon inflation speed. Taking the terminal device as a mobile phone, the adjusted display interface is shown in FIG. 4.

In an embodiment, in a case that it is detected that the state attribute of the target part of the user does not meet the preset state attribute condition, the display form of the target virtual prop is adjusted to the initial form. That is, in a case that the target user changes the state information of the mouth (that is a process of performing a mouth-pouting action to not performing the mouth-pouting action) in blowing the balloon by the target user, the balloon below the mouth of the target user is adjusted to be the small balloon in the initial deflated state.

In an embodiment, the display size of the balloon on the screen of the terminal may be adjusted only based on the detected state information of the mouth of the target user and the face shape change information of the target user. Specifically, in a case that a state attribute of the target part meets a preset state attribute condition, a display form adjustment range of the target virtual prop in a time period is determined based on detected face shape change information of the target user; and the display form of the target virtual prop is adjusted based on the determined display form adjustment range.

Specifically, in a case that it is detected that the mouth of the target user is in the mouth-pouting state, the mouth opening range and cheek bulging range corresponding to the face of the target user are detected. Based on the mouth opening range and the cheek bulging range of the current target user and the determined relationship between the face shape change information and the balloon inflation speed, a change degree of the size of the balloon (that is, a balloon inflation degree) in a time period is determined. Based on the determined change degree of the size of the balloon in the time period, a display size of the balloon on the screen of the terminal is adjusted.

According to the embodiments of the present disclosure, the user may control a display form of a virtual prop in real time, realizing cooperative display of a face image of the user and the virtual prop, thereby enhancing the real experience of operating virtual props. In addition, virtual props replace real props, saving material costs, protecting environment (reducing real prop garbage), and facilitating the statistics of the operation results. Furthermore, in the embodiments of the present disclosure, the position of the target virtual prop relative to the target part matches the position of the real target operation object, when being operated in the real scenario, relative to the target part. Therefore, the operations performed on the virtual prop in the embodiments of the present disclosure match the real scenario.

In an embodiment, after the display form of the target virtual prop is adjusted based on the detected state information of the target part, the method further includes: after adjusting the display form of the target virtual prop to meet a preset condition, displaying a target animation effect corresponding to the target virtual prop.

The preset condition is a size threshold of the target virtual prop. In the embodiment, the preset condition is a maximum expansion size of the balloon.

The target animation effect is an effect that the virtual balloon is blown up or blown away or the like. Specifically, the displaying the target animation effect of the target virtual prop may be displaying an animation effect of the virtual balloon being blown up or blown away.

Specifically, after adjusting the size of the balloon shown on the screen of the terminal based on the detected mouth state information of the target user, the effect that the balloon is blown up or blown away is displayed when the size of the balloon is adjusted to be greater than the maximum expansion size of the balloon. For example, when the terminal device detects that the size of the balloon shown on the screen of the terminal has reached the maximum expansion size in the process the target user blowing the balloon, in a case that it is detected that the target user is still in the mouth-pouting state and the sound attribute meets the preset sound attribute condition (that is, it is detected that the target user is still blowing the balloon), an animation effect of the balloon exploding is displayed on the screen of the terminal.

In an embodiment, based on prop attribute information of the target virtual prop, a target animation effect matching the prop attribute information is displayed.

The prop attribute information may include: a prop type and a reality effect corresponding to the prop type. The prop type includes a bomb type, a cloud type, and the like. A reality effect corresponding to the bomb type is an explosion effect, and a reality effect corresponding to the cloud type is a floating effect.

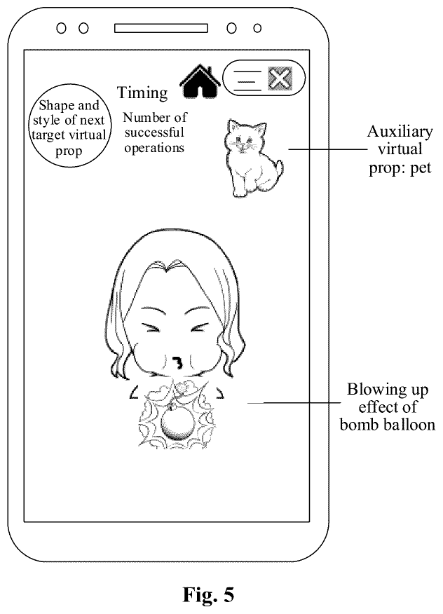

Exemplary, in a case that the target virtual prop is a bomb balloon, based on the prop attribute information of the target virtual prop, it is determined to display an animation effect same as the reality effect corresponding to the bomb, that is, to display a blowing up effect of the bomb balloon on the screen of the terminal. Taking the terminal device as a mobile phone, the display interface is shown in FIG. 5.

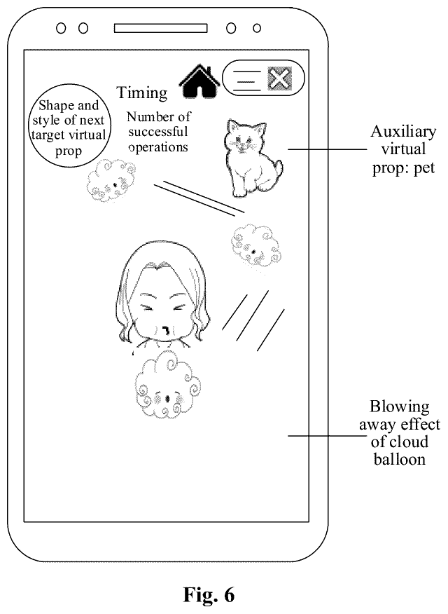

Exemplary, in a case that the target virtual prop is a cloud balloon, based on the prop attribute information of the target virtual prop, it is determined to display an animation effect same as the reality effect corresponding to the cloud, that is, to display a blowing away effect of the cloud balloon on the screen of the terminal. Taking the terminal device as a mobile phone, the display interface is shown in FIG. 6.

In an embodiment, after adjusting the display form of the target virtual prop based on the detected state information of the target part, the method further includes: after adjusting the display form of the target virtual prop to meet a preset condition, updating a recorded successful operation number, and displaying the target virtual prop in the initial display form.

The successful operation number may be the number of successfully blowing up the balloon, that is, the number of the balloons being successfully blown up. The prop attribute of the target virtual prop in the initial form may be the same as or different from the prop attribute of the previous virtual prop in the initial form. The prop attribute may include a color, a shape, a type, and the like.

Specifically, after adjusting the size of the balloon shown on the screen of the terminal based on the detected mouth state information of the target user, when the size of the balloon is adjusted to be greater than the maximum expansion size of the balloon, the number of successfully blowing up balloon is update, and a small deflated balloon (the shape, color, and type of the small balloon may be the same as or different from the previous balloon) is displayed below the mouth of the target user. That is, when the terminal device detects that the size of the balloon shown on the screen of the terminal has reached the maximum expansion size in the process the target user blowing the balloon, in a case that it is detected that the target user is still in the mouth-pouting state and the sound attribute meets the preset sound attribute condition (that is, it is detected that the target user is still blowing the balloon), the balloon is successfully blown up, the number of successfully blowing up the balloon is updated, and a small deflated balloon is displayed below the mouth of the target user.

In order to further enrich the operation scenarios, in an embodiment, the method further includes: obtaining a personalized to-be-added object; and generating the target virtual prop based on the obtained personalized to-be-added object and a preset virtual prop model.

The personalized to-be-added object may be a DIY (do it yourself) object, such as a sticker and a photo.

Specifically, the target user may select a DIY object, such as a photos and a sticker that the target user likes or is interested in, and add the DIY object to the preset virtual prop model based on a preset rule to generate a target virtual prop.

Exemplary, the user selects a DIY button on the terminal device to add a favorite Snow White image to the balloon prop model to generate a balloon containing the Snow White image, and the balloon containing the Snow White image is displayed on the screen of the terminal device.

In an embodiment, the method further includes: displaying an auxiliary virtual prop in a preset position region on a screen displaying the face image; and in response to adjusting the display form of the target virtual prop to meet a preset condition, changing a display effect of the auxiliary virtual prop.

The auxiliary virtual prop may be a virtual pet, a virtual character, and the like, such as a virtual cat, a virtual dog, and a virtual smiling face character. The preset position region may be any region outside the region where the face image is located on the screen of the terminal.

The display effect of the auxiliary virtual prop may include an applauding effect, a clapping effect, a thumbing up effect, and the like.

Specifically, the auxiliary virtual prop is displayed in the preset region on the screen of the terminal device. When the terminal device detects that the size of the balloon shown on the screen of the terminal has reached the maximum expansion size in the process the target user blowing the balloon, in a case that it is detected that the target user is still in the mouth-pouting state and the sound attribute meets the preset sound attribute condition (that is, it is detected that the target user is still blowing the balloon), the target user successfully blows up the balloon, and the display effect of the auxiliary virtual prop is adjusted when it is detected that the target user has successfully blown up the balloon.

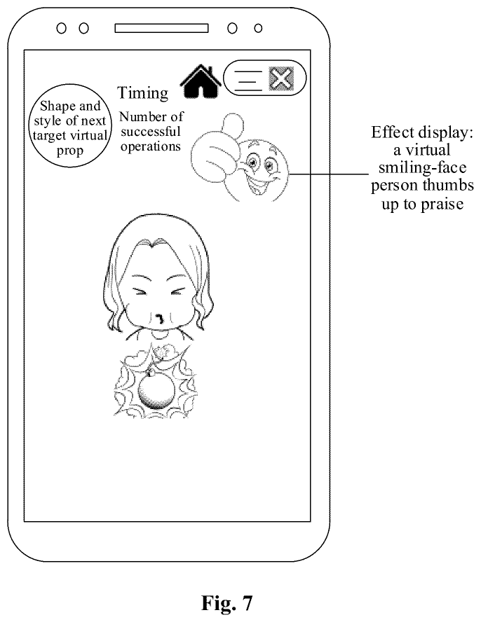

Exemplary, in a case that the auxiliary virtual prop displayed in the preset region on the screen of the terminal device is a virtual smiling face, when it is detected that the user successfully blows up the balloon, the display effect of the virtual smiling face is adjusted to be the thumbing up effect. Taking the terminal device as a mobile phone, the display interface is shown in FIG. 7.

In an embodiment, in a case that the face image of the target user includes face images of multiple target users, for each of the target users, based on detected position information of a target part of the target user, a target virtual prop, in an initial display form, is displayed at a relative position corresponding to the detected position information on a face image of the target user.

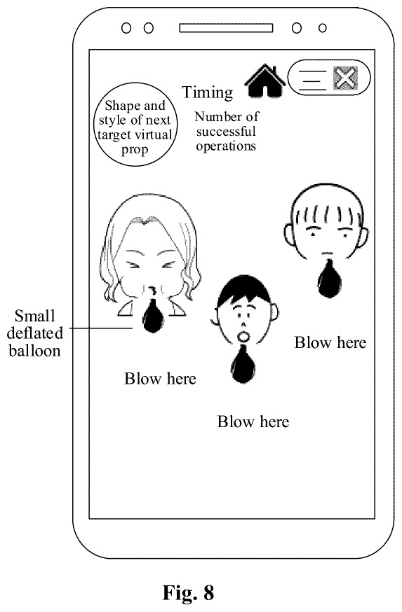

Specifically, in a case that the face image of the target user obtained by the terminal device includes face images of multiple target users, feature extraction is performed on each of the face images of target users. Based on attribute information of a feature extraction result, for each of the target users, position information of a mouth of the target user is determined, and a target virtual prop in an the initial form (that is, a small balloon in a deflated state) is displayed under the mouth of the target user based on the position information of the mouth of target user. Taking the terminal device as a mobile phone, the display interface is shown in FIG. 8.

In addition, in an embodiment of the present disclosure, a multi-person interaction scenario may be displayed. In this scenario, multiple target users may compete for an operation authority of a target virtual prop (where different target users may have corresponding target virtual props, and only a winner may perform operations). For example, in an embodiment, in a case that face images of multiple target users are obtained, the display form of the target virtual prop may be adjusted based on the detected state information of the target part by: based on detected state information of target parts of all the target users and detected face shape change information of all the target users, determining a selected user from the target users, and adjusting a display form of a target virtual prop corresponding to the selected user.

In another multi-person interaction scenario, a user performing operations quickly among multiple target users may be determined by: based on detected state information of target parts of all the target users, adjusting a display form of a target virtual prop corresponding to each of the target users.

Specifically, in a case that the face image of the target user obtained by the terminal device includes face images of multiple target users, feature extraction is performed on the face images of all the target users, state information (that is, the mouth-pouting state or the blowing state) of mouths of all the target users and corresponding face change information (that is, the mouth opening range and the cheek bulging range) of all the target users are determined. Based on the state information of the mouths and the corresponding face change information of all the target users, sizes of balloons below the mouths of all the target users are adjusted.

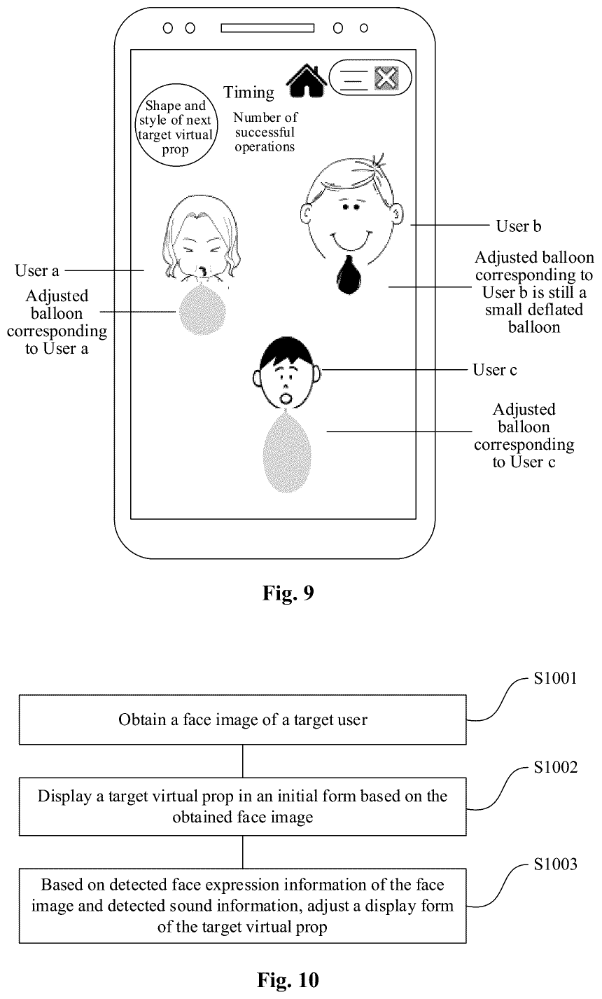

Exemplary, in a case that the face image of the target user obtained by the terminal device include face images of three target users (user a, user b, and user c), feature extraction is performed on each of the face images of the three target users. It is determined that: the state information of the mouth of the user a includes a mouth-pouting state, a blowing state, and a sound at 2 decibels and with a time duration of 4 seconds; and a mouth opening range and a cheek bulging range corresponding to the user a are large. It is determined that: the state information of the mouth of the user b includes a smiling state, and the user b does not open mouth. It is determined that: the state information of the mouth of the user c includes: a mouth-pouting state, a blowing state, and a sound at 1.5 decibels and with a time duration of 4 seconds; and a mouth opening range and a cheek bulging range corresponding to the user c are small. Based on the state information of the mouth, the mouth opening ranges and the cheek bulging ranges of the user a, user b and user c, the size of the balloon below the mouth of the user a is adjusted to 4 times an initial size, the size of the balloon below the mouth of the user b is not adjusted, and the size of the balloon below the mouth of the user c is adjusted to twice the initial size. Taking the terminal device as a mobile phone, the display interface is shown in FIG. 9.

In an embodiment of the present disclosure, video recording may be performed for the pictures in the above operation processes, and the recorded video may be shared through a social APP. For example, video recording may be performed while capturing the face image. After the whole operation process, the recorded video is saved and shared to the social APP.

### Second Embodiment

Reference is made to FIG. 10, which shows a flow chart of an operation control method according to another embodiment of the present disclosure. The method includes the following steps S1001 to S1003.

In step S1001, a face image of a target user is obtained.

In step S1002, a target virtual prop in an initial form is displayed based on the obtained face image.

Referring to the descriptions in the first embodiment, after obtaining the face image of the target user, the position information of the target part in the face image may be detected, and based on the detected position information, the target virtual prop in the initial form is displayed at the relative position corresponding to the detected position information on the face image.

In step S1003, based on detected face expression information of the face image and detected sound information, a display form of the target virtual prop is adjusted.

The face expression information may include the state information of the target part and/or face shape change range information. The state information of the target part may be information indicating whether in a mouth-pouting state. The sound information may include information about a sound type, information about a sound size, information about a sound duration and other information.

In an embodiment, feature extraction is performed on the face image of the target user to determine information such as the state information (indicating whether in a mouth-pouting state) of the target part and the face shape change range information (including a cheek bulging range and a mouth opening-closing motion range). In addition, sound data of the target user may be obtained. The sound data is processed to determine sound information corresponding to the sound data. Based on the state information of the target part, the face shape change range information and the sound information, a display size of the target virtual prop is adjusted.

In implementation, the descriptions about adjusting the display form of the target virtual prop based on the detected face expression information of the face image and the detected sound information may refer to the descriptions in the first embodiment, and are not repeated herein.

Those skilled in the art should understand that in the method according to the embodiments of the present disclosure, the order in which the steps are described is not a strict execution order and does not limit the implementation process. The order in which the steps are executed is determined based on the functions and possible internal logic of the steps.

Based on the same inventive concept, an operation control apparatus corresponding to the operation control method is further provided according to an embodiment of the present disclosure. Since the principle of solving problems by the apparatus in the embodiment of the present disclosure is similar to the operation control method in the embodiments of the present disclosure, the implementation of the apparatus may refer to the implementation of the method, and is not repeated.

### Third Embodiment

Reference is made to FIG. 11, which shows a schematic diagram of an operation control apparatus 1100 according to an embodiment of the present disclosure. The apparatus includes: an obtaining module 1101, a detection module 1102, a displaying module 1103, and an adjustment module 1104.

The obtaining module 1101 is configured to obtain a face image of a target user.

The detection module 1102 is configured to detect position information of a target part in the face image.

The displaying module 1103 is configured to, based on the detected position information, display a target virtual prop in an initial display form at a relative position corresponding to the detected position information on the face image.

The adjustment module 1104 is configured to adjust a display form of the target virtual prop based on detected state information of the target part.

According to the embodiments of the present disclosure, the user may control a display form of a virtual prop in real time, realizing cooperative display of a face image of the user and the virtual prop, thereby enhancing the real experience of operating virtual props. In addition, virtual props replace real props, saving material costs, protecting environment (reducing real prop garbage), and facilitating the statistics of the operation results. Furthermore, in the embodiments of the present disclosure, the position of the target virtual prop relative to the target part matches the position of the real target operation object, when being operated in the real scenario, relative to the target part. Therefore, the operations performed on the virtual prop in the embodiments of the present disclosure match the real scenario.

In an embodiment, the display form includes a display shape and/or a display size.

In an embodiment, the adjustment module 1104 is configured to: adjust the display form of the target virtual prop in a case that it is detected that a state attribute of the target part meets a preset state attribute condition and it is detected that a sound attribute meets a preset sound attribute condition.

In an embodiment, the adjustment module 1104 is configured to: in the case that the state attribute of the target part meets the preset state attribute condition and the sound attribute meets the preset sound attribute condition, determine a display form adjustment range of the target virtual prop in a time period based on detected face shape change information of the target user; and adjust the display form of the target virtual prop based on the determined display form adjustment range.

In an embodiment, the adjustment module 1104 is configured to: in a case that a state attribute of the target part meets a preset state attribute condition, determine a display form adjustment range of the target virtual prop in a time period based on detected face shape change information of the target user; and adjust the display form of the target virtual prop based on the determined display form adjustment range.

In an embodiment, the target part is in a mouth-pouting state.

In an embodiment, that the sound attribute meets the preset sound attribute condition includes that it is detected that a sound volume is greater than a preset threshold and/or it is detected that a sound type is a preset sound type.

In an embodiment, the apparatus further includes a target animation effect displaying module. The target animation effect displaying module is configured to, after the display form of the target virtual prop is adjusted to meet a preset condition, display a target animation effect corresponding to the target virtual prop.

In an embodiment, the target animation effect displaying module is configured to display a target animation effect that a virtual balloon is blown up or blown away.

In an embodiment, the target animation effect displaying module is configured to, based on prop attribute information of the target virtual prop, display a target animation effect matching the prop attribute information.

In an embodiment, the apparatus further includes a counting update module. The counting update module is configured to, after the display form of the target virtual prop is adjusted to meet a preset condition, update a recorded successful operation number, and display the target virtual prop in the initial display form.

In an embodiment, the apparatus further includes a personalized setting module. The personalized setting module is configured to: obtain a personalized to-be-added object; and generate the target virtual prop based on the obtained personalized to-be-added object and a preset virtual prop model.

In an embodiment, the apparatus further includes an auxiliary virtual prop displaying module. The auxiliary virtual prop displaying module is configured to display an auxiliary virtual prop in a preset position region on a screen displaying the face image.

The auxiliary virtual prop displaying module is configured to, in response to that the display form of the target virtual prop is adjusted to meet a preset condition, change a display effect of the auxiliary virtual prop.

In an embodiment, the face image of the target user includes face images of multiple target users. The displaying module 1103 is further configured to, for each of the target users, based on detected position information of a target part of the target user, display a target virtual prop in an initial display form at a relative position corresponding to the detected position information on a face image of the target user.

In an embodiment, the adjustment module 1104 is further configured to, based on detected state information of target parts of all the target users and detected face shape change information of all the target users, determine a selected user from the target users, and adjust a display form of a target virtual prop corresponding to the selected user.

In an embodiment, the adjustment module 1104 is further configured to, based on detected state information of target parts of all the target users, adjust a display form of a target virtual prop corresponding to each of the target users.

In an embodiment, the target virtual prop corresponds to a real target operation object in a real scenario, and a position of the target virtual prop relative to the target part matches a position of the real target operation object, when being operated in the real scenario, relative to the target part.

### Fourth Embodiment

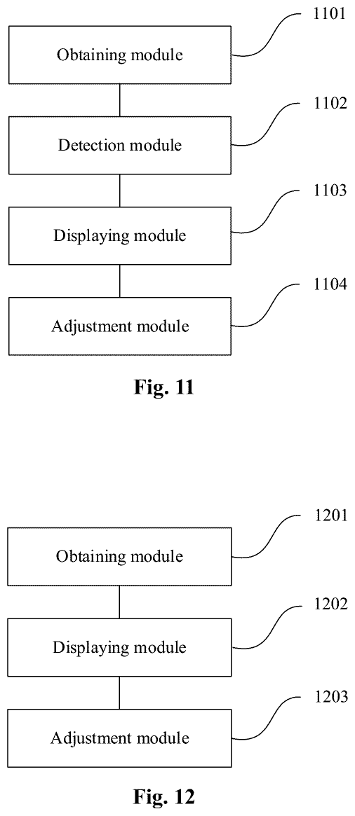

Reference is made to FIG. 12, which shows a schematic diagram of an operation control apparatus 1200 according to an embodiment of the present disclosure. The apparatus includes: an obtaining module 1201, a displaying module 1202, and an adjustment module 1203.

The obtaining module 1201 is configured to obtain a face image of a target user.

The displaying module 1202 is configured to display a target virtual prop in an initial form based on the obtained face image.

The adjustment module 1203 is configured to, based on detected face expression information of the face image and detected sound information, adjust a display form of the target virtual prop.

The descriptions about the processes of the modules in the apparatus, the interaction processed between the modules and the beneficial effects may refer to the descriptions in the method embodiments, which are not detailed herein.

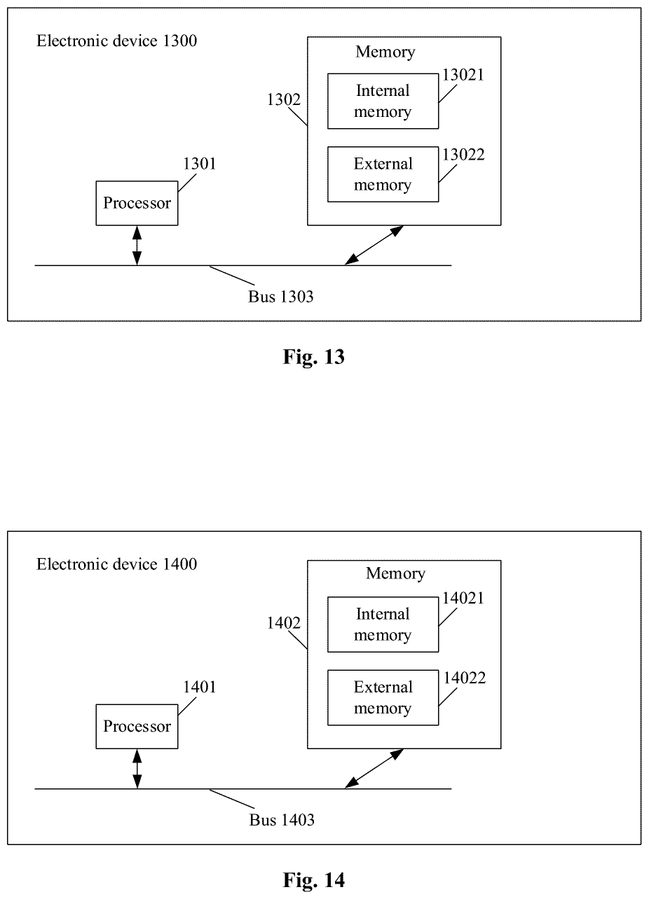

Based on the same technical concept, an electronic device is further provided according to an embodiment of the present disclosure. Reference is made to FIG. 13, which shows a schematic diagram of an electronic device 1300 according to an embodiment of the present disclosure. The electronic device 1300 includes a processor 1301, a memory 1302, and a bus 1303. The memory 1302 stores execution instructions, and includes an internal memory 13021 and an external memory 13022. The internal memory 13021 is configured to temporarily store the operation data in the processor 1301 and the data exchanged with the external memory 13022 such as a hard disk. The processor 1301 exchanges data with the external memory 13022 through the internal memory 13021. When the electronic device 1300 operates, the processor 1301 communicates with the memory 1302 through the bus 1303 to cause the processor 1301 to: obtain a face image of a target user; detect position information of a target part in the face image; based on the detected position information, display a target virtual prop in an initial display form at a relative position corresponding to the detected position information on the face image; and adjust a display form of the target virtual prop based on detected state information of the target part.

Based on the same technical concept, an electronic device is further provided according to an embodiment of the present disclosure. Reference is made to FIG. 14, which shows a schematic diagram of an electronic device 1400 according to an embodiment of the present disclosure. The electronic device 1400 includes a processor 1401, a memory 1402, and a bus 1403. The memory 1402 stores execution instructions, and includes an internal memory 14021 and an external memory 14022. The internal memory 14021 is configured to temporarily store the operation data in the processor 1401 and the data exchanged with the external memory 14022 such as a hard disk. The processor 1401 exchanges data with the external memory 14022 through the internal memory 14021. When the electronic device 1400 operates, the processor 1401 communicates with the memory 1402 through the bus 1403 to cause the processor 1401 to: obtain a face image of a target user; display a target virtual prop in an initial form based on the obtained face image; and based on detected face expression information of the face image and detected sound information, adjust a display form of the target virtual prop.

A computer-readable storage medium is further provided according to an embodiment of the present disclosure. The computer-readable storage medium stores a computer program. The computer program, when executed by a processor, causes the processor to perform the operation control methods according to the method embodiments. The storage medium may be a volatile computer-readable storage medium or a nonvolatile computer-readable storage medium.

A computer program product of the operation control method according to an embodiment of the present disclosure includes the computer-readable storage medium storing program codes. Instructions included in the program codes may be executed to perform the steps of the operation control methods according to the method embodiments. The steps of the operation control methods may refer to the method embodiments, and are not repeated herein.

A computer program is further provided according to an embodiment of the present disclosure. The computer program, when executed by a processor, causes the processor to perform the method according to any one of the above embodiments. The computer program product may be implemented by hardware, software or a combination thereof. In an embodiment, the computer program product is implemented as a computer storage medium. In another embodiment, the computer program product is implemented as a software product, such as a software development kit (SDK).

Those skilled in the art may clearly understand that, for the convenience and simplicity of description, the operation processes of the system and device described above may refer to the corresponding processes in the method embodiments, and are not repeated herein. Based on the embodiments of the present disclosure, it should be understood that the disclosed system, device and method may be implemented in other ways. The device embodiments described above are only schematic. For example, the division of the units is only a logical function division, and there can be another division manner in actual implementations. For another example, multiple units or components may be combined or integrated into another system, or some features may be ignored or may be not implemented. In addition, the mutual coupling or direct coupling or communication connection shown or discussed above may be indirect coupling or communication connection through some communication interfaces, devices or units, and may be in an electrical form, in a mechanical form, or in other forms.

Units described as separate components may or may not be physically separated. Components displayed as units may or may not be physical units, that is, the components may be located in one place or may be distributed to multiple network units. Some or all of the units may be selected according to actual requirements to achieve the purpose of the solutions according to the embodiments of the present disclosure.

In addition, the functional units in the embodiments of the present disclosure may be integrated in a processing unit, or each of the units may exist physically independently, or two or more units may be integrated in a unit.

If functions are performed in the form of a software functional unit and are sold or used as an independent product, the functions may be stored in a nonvolatile computer readable storage medium that can be executed by a processor. Based on the above understanding, the technical solutions according to the present disclosure or the part of the technical solutions contributing to the prior art or a part of the technical solutions may be implemented in the form of a software product. The computer software product is stored in a storage medium, and includes instructions to cause a computer device (which may be a personal computer, a server, a network device, or the like) to perform all or part of the steps of the method described in embodiments of the present disclosure. The storage media includes a media that may store program codes, such as a USB flash disk, a mobile hard disk, a read only memory (ROM), a random access memory (RAM), a magnetic disc and an optical disc.

Finally, it should be noted that the above embodiments are only specific embodiments of the present disclosure to illustrate the technical solutions in the present disclosure, rather than limit the present disclosure. The protection scope of the present disclosure is not limited to the embodiment. Although the present disclosure is described in detail with reference to the embodiments, those skilled in the art should understand that any one skilled in the art may still modify or easily think of changes in the technical solutions recorded in the embodiments or substitute some of the technical features within the technical scope of the present disclosure. These modifications, changes or substitutions do not make the technical solutions separate from the spirit and scope of the technical solutions in the embodiments of the present disclosure, and should be included in the protection scope of the present disclosure. Therefore, the protection scope of the present disclosure should be consistent with the protection scope of the claims.

1. An operation control method, comprising:
obtaining a face image of a target user;
detecting position information of a target part in the face image;
based on the detected position information, displaying a target virtual prop, in an initial display form, at a relative position corresponding to the detected position information on the face image; and
adjusting a display form of the target virtual prop based on detected state information of the target part.

2. The method according to claim 1, wherein the display form comprises a display shape and/or a display size.

3. The method according to claim 1, wherein the adjusting a display form of the target virtual prop based on detected state information of the target part comprises:
adjusting the display form of the target virtual prop in a case that it is detected that a state attribute of the target part meets a preset state attribute condition and it is detected that a sound attribute meets a preset sound attribute condition.

4. The method according to claim 3, wherein the adjusting the display form of the target virtual prop in a case that it is detected that a state attribute of the target part meets a preset state attribute condition and it is detected that a sound attribute meets a preset sound attribute condition comprises:
in the case that the state attribute of the target part meets the preset state attribute condition and the sound attribute meets the preset sound attribute condition, determining a display form adjustment range of the target virtual prop in a time period based on detected face shape change information of the target user; and
adjusting the display form of the target virtual prop based on the determined display form adjustment range.

5. The method according to claim 1, wherein the adjusting a display form of the target virtual prop based on detected state information of the target part comprises:
in a case that a state attribute of the target part meets a preset state attribute condition, determining a display form adjustment range of the target virtual prop in a time period based on detected face shape change information of the target user; and
adjusting the display form of the target virtual prop based on the determined display form adjustment range.

6. The method according to claim 3, wherein in a case that the target part is a mouth and the target virtual prop is a virtual balloon, that the state attribute of the target part meets the preset state attribute condition comprises that the target part is in a mouth-pouting state.

7. The method according to claim 3, wherein that the sound attribute meets the preset sound attribute condition comprises that it is detected that a sound volume is greater than a preset threshold and/or it is detected that a sound type is a preset sound type.

8. The method according to claim 1, wherein after adjusting the display form of the target virtual prop based on the detected state information of the target part, the method further comprises:
after adjusting the display form of the target virtual prop to meet a preset condition, displaying a target animation effect corresponding to the target virtual prop.

9. The method according to claim 8, wherein in a case that the target part is a mouth and the target virtual prop is a virtual balloon, the displaying a target animation effect corresponding to the target virtual prop comprises:
displaying a target animation effect that the virtual balloon is blown up or blown away.

10. The method according to claim 9, wherein the after adjusting the display form of the target virtual prop to meet a preset condition, displaying a target animation effect corresponding to the target virtual prop comprises:
based on prop attribute information of the target virtual prop, displaying a target animation effect matching the prop attribute information.

11. The method according to claim 1, wherein after adjusting the display form of the target virtual prop based on the detected state information of the target part, the method further comprises:
after adjusting the display form of the target virtual prop to meet a preset condition, updating a recorded successful operation number, and displaying the target virtual prop in the initial display form.

12. The method according to claim 1, further comprising:
obtaining a personalized to-be-added object; and
generating the target virtual prop based on the obtained personalized to-be-added object and a preset virtual prop model.

13. The method according to claim 1, further comprising:
displaying an auxiliary virtual prop in a preset position region on a screen displaying the face image; and
in response to adjusting the display form of the target virtual prop to meet a preset condition, changing a display effect of the auxiliary virtual prop.

14. The method according to claim 1, wherein
the face image of the target user comprises face images of a plurality of target users; and
for each of the target users, based on detected position information of a target part of the target user, a target virtual prop, in an initial display form, is displayed at a relative position corresponding to the detected position information on a face image of the target user.

15. The method according to claim 14, wherein the adjusting a display form of the target virtual prop based on detected state information of the target part comprises:
based on detected state information of target parts of all the target users and detected face shape change information of all the target users, determining a selected user from the target users, and adjusting a display form of a target virtual prop corresponding to the selected user.

16. The method according to claim 14, wherein the adjusting a display form of the target virtual prop based on detected state information of the target part comprises:
based on detected state information of target parts of all the target users, adjusting a display form of a target virtual prop corresponding to each of the target users.

17. An operation control method, comprising:
obtaining a face image of a target user;
displaying a target virtual prop in an initial form based on the obtained face image; and
based on detected face expression information of the face image and detected sound information, adjusting a display form of the target virtual prop.

18. An operation control apparatus, comprising:
at least one processor; and
at least one memory communicatively coupled to the at least one processor and storing instructions that upon execution by the at least one processor cause the apparatus to:
obtain a face image of a target user;
detect position information of a target part in the face image;
based on the detected position information, display a target virtual prop, in an initial display form, at a relative position corresponding to the detected position information on the face image; and
adjust a display form of the target virtual prop based on detected state information of the target part.

19. An operation control apparatus, comprising:
at least one memory communicatively coupled to the at least one processor and storing instructions that upon execution by the at least one processor cause the apparatus to: perform the operation control method according to claim 1.

20. (canceled)

21. A computer-readable non-transitory storage medium storing a computer program, wherein the computer program, when executed by a processor, causes the processor to perform the operation control method according to claim 1.
